(19) United States
(12) Patent Application Publication
(10) Pub. No.: US 2022/0156662 A1
(43) Pub. Date: May 19, 2022

(54) System and Method for Automated Lawn Service Price Estimation and Scheduling

(71) Applicant: Christopher Richard Pickreign, Harvard, MA (US)

(72) Inventor: Christopher Richard Pickreign, Harvard, MA (US)

(21) Appl. No.: 17/513,453

(22) Filed: Oct. 28, 2021

Related U.S. Application Data
(60) Provisional application No. 63/106,654, filed on Oct. 28, 2020.

(51) Int. Cl. G06Q 10/06; G06Q 30/02

(52) U.S. Cl. CPC G06Q 10/06315; G06Q 10/06311; G06Q 30/0206

(57) ABSTRACT

A computer-implemented method and corresponding system automate lawn service price estimation and scheduling. The method determines at least one physical feature of the topography. The topography is associated with a received physical address of a residence. The received address identifies a physical location associated with the topography. The method estimates parameters to perform a lawn service at the residence based on the at least one physical feature determined. The estimating employs machine learning. The method computes a cost estimate for the lawn service at the residence, automatically, based on the parameters estimated. The method computes a price estimate and outputs the price estimate computed to an electronic device. The automated lawn service price estimation enables a lawn service professional to provide price estimates to a customer, automatically, without having to travel to the residence to observe and perform physical measurements of the topography.

### CROSS-REFERENCE TO RELATED APPLICATION

This application claims the benefit of U.S. Provisional Patent Application No. 63/106,654, filed on Oct. 28, 2020, the disclosure of which is incorporated by reference herein in its entirety.

### BACKGROUND

An application, application program, or application software, often referred to as an “app,” is a computer program designed to carry out a specific task other than one relating to the operation of the computer itself. Such a computer program is designed to help people perform an activity. The term “app” often refers to applications for mobile devices, such as smart phones, but is not limited thereto.

### SUMMARY

The example and non-limiting embodiments disclosed herein relate generally to lawn service systems and, more particularly, to a system and method for automated lawn service price estimation and scheduling that provides automatic, immediate responses to customer requests.

The following summary is merely intended to be exemplary. The summary is not intended to limit the scope of the claims. A residence, as disclosed herein, may be interchangeably referred to as a property. While a physical address disclosed herein may referred to as a physical address of a residence, it should be understood that such physical address may refer to any physical location of a property at which a lawn service(s) is requested to be provided. For example, it is not necessary that a dwelling exist at the physical address and the property is not limited to a residential property. The property may, for example, be an area of land without a dwelling, or a commercial property, such as a hospital, assembly plant, office space, or other location used for a business enterprise for non-limiting example, and for which a lawn service(s) is requested.

According to an example embodiment, a computer-implemented method for automating lawn service price estimation and scheduling comprises determining at least one physical feature of a topography. The topography is associated with a received physical address of a residence (property). The received address identifies a physical location associated with the topography. The computer-implemented method further comprises estimating parameters to perform a lawn service at the residence based on the at least one physical feature determined. The estimating employs machine learning. The computer-implemented method further comprises computing a cost estimate for the lawn service at the residence, automatically, based on the parameters estimated. The computer-implemented method further comprises computing a price estimate based on at least the cost estimate for lawn services at the residence and outputting the price estimate computed to an electronic device. Such outputting may include output, directly, for example, to a user interface of the electronic device for non-limiting example. Alternatively, the outputting may include outputting the price estimate, indirectly, for example, via an electronic communication, such as an electronic text message or electronic mail (e-mail) for non-limiting example, that is received by the electronic device.

The machine learning may employ position and time tracking information obtained from at least one global positioning system (GPS) coupled to lawn service equipment employed for performing the lawn service.

The estimating may include employing at least one neural network for performing the machine learning.

Determining the at least one physical feature may be based on satellite imagery of the topography.

The at least one physical feature may include service zones, complexity of the topography, exclusion zone, or a combination thereof, of the topography.

The complexity may be based on at least one gradient of the topography.

The computing may be based on at least one constraint for performing the lawn service.

The at least one constraint may include a maximum number of persons for performing the lawn service, a maximum amount of time for performing the lawn service, at least one type of equipment for performing the lawn service, or a combination thereof.

The computing may be based on a wealth profile of a community within which the residence resides.

The computing may be based on an expected gross margin.

The computing may be based on an expected amount of gasoline to be consumed by equipment for performing the lawn service.

The computing may be based on a target profit amount for performing the lawn service.

The computer-implemented method may further comprise determining a schedule for at least one person employed for performing the lawn service, the schedule determined based on the estimating and the physical location.

The lawn service may comprise mowing, trimming, blowing, collecting, or a combination thereof, of grass of the topography. It should be understood, however, that the lawn service is not limited thereto.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic view illustrating features of one example embodiment of an automated lawn service price estimation and scheduling system.

FIG. 1B is a flow diagram of an example embodiment of a computer-implemented method for automating lawn service price estimation and scheduling.

FIG. 2 is a schematic view of an example embodiment of an image blob of the automated lawn service price estimation and scheduling system of FIG. 1A.

FIG. 3 is a schematic view of an example embodiment of a Software Application and Peripheral I/O and Communication Devices of the automated lawn service price estimation and scheduling system of FIG. 1A.

FIG. 4 is a flow diagram of an example embodiment of a User Interface method for the Software Application of FIG. 3.

FIG. 5 is a flow diagram of an example embodiment of the Software Application of FIG. 3.

FIG. 6 is a flow diagram of an example embodiment of an Image AI method for the Software Application of FIG. 3.

FIG. 7 is a flow diagram of an example embodiment of an Estimation AI for the Software Application of FIG. 3.

FIG. 8 is a flow diagram of an example embodiment of a Scheduler Component for the Software Application of FIG. 3.

### DETAILED DESCRIPTION

A description of example embodiments follows.

An example embodiment disclosed herein includes a deep learning artificial intelligence (AI) based decision making model/system/platform for automated lawn service estimation and scheduling.

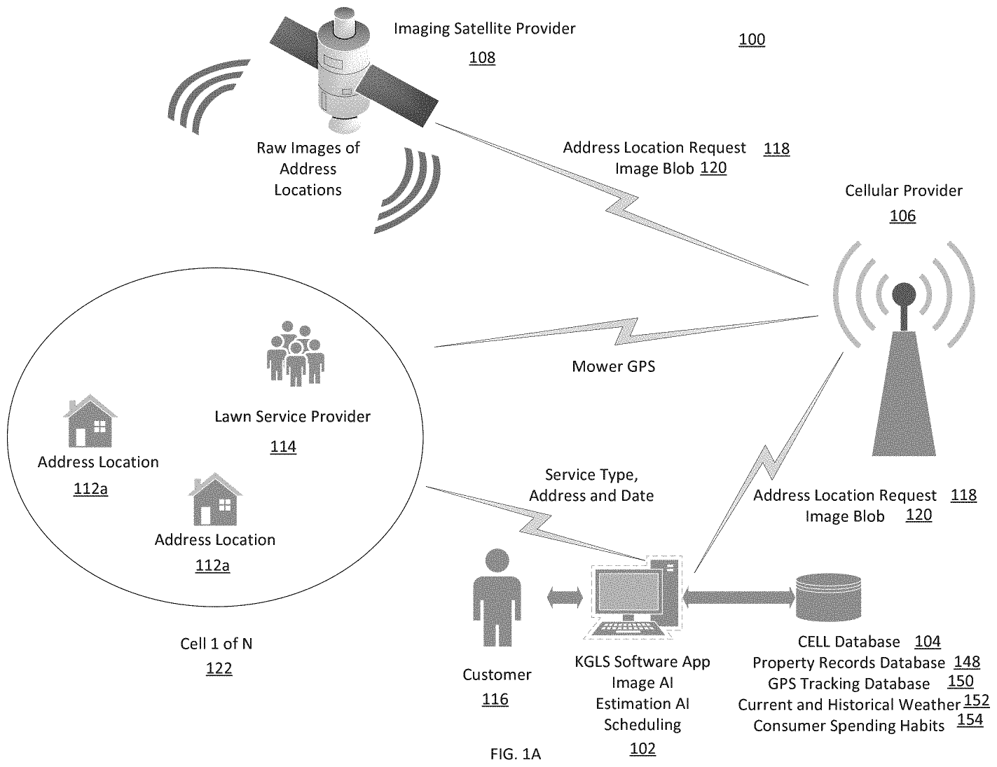

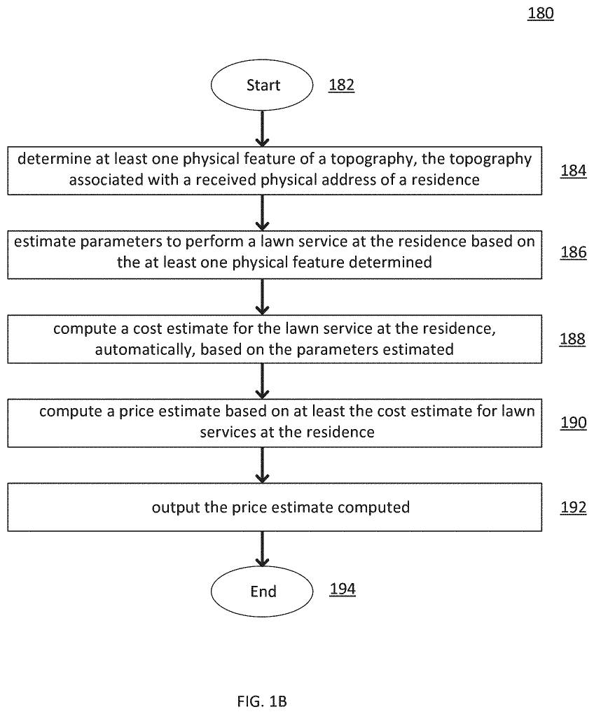

FIG. 1A is a schematic view illustrating features of one example embodiment of an automated lawn service price estimation and scheduling system 100. In one example embodiment, the Automated Lawn Service Price Estimation and Scheduling system 100 according to the present disclosure may comprise a KGLS Software Application 102, CELL Database 104, Cellular Provider 106, an Imaging Satellite Provider 108 and Cell 122 having Customer Residences (properties) 112a . . . 112n and a group of Lawn Care Providers 114, as disclosed in FIG. 1A. A Customer (User) 116 may access the KGLS Software Application 102 through any browser application on any computer type, or alternatively, any smart phone or device. In alternative embodiments, the Customer 116 may access the KGLS Software Application 102 by any computing device having access to the internet through either a wired or wireless connection. It is noted that the KGLS Software Application 102 is a trademark associated with Kelly Green Lawn Services, LLC and alternatively, any name may be used.

The Customer 116 may input a Customer Address location to the KGLS Software Application 102 user interface (not shown) and select a Submit button (not shown). Alternatively, any reasonable submission process known to those skilled in the art may be used. Upon submitting the Customer Address, a price offering and service date is provided to the Customer 116 almost instantaneously. In an alternative embodiment, the Customer 116 may input a Customer Address Location and also select a type of service requested. The types of service may be displayed in a pull-down list (not shown), or alternatively any other selection method may be displayed. The types of service may include at least lawn mowing, trimming (weed whacking), pruning bushes, grass (leaf) blowing and collection, or a combination thereof, for non-limiting example. “Almost instantaneously” as referred to in this disclosure shall mean providing the price offering and service date to the Customer 116 in a reasonably acceptable time to ensure high Customer satisfaction. The Customer 116 may either Accept or Reject the offered price and/or the service date.

Upon submission of the Customer Address by the Customer 116, an Address Location Request 118 is communicated to a Cellular Provider 106 and then relayed to a Satellite Imaging Provider 108. The wireless communications between the KGLS Software Application 102, Cellular Provider 106 and the Imaging Satellite Provider 108 may be 2G, WiFi, 3G, 4G, 5G or any reasonable wireless communications protocol, for non-limiting example. The Cellular Provider 106 may be any major Cell provider for non-limiting example. The Imaging Satellite Provider 108 may be Google Earth or any other reasonable satellite imaging service for non-limiting example.

Upon receiving the Address Location Request 118, the Imaging Satellite Provider 108 may communicate an Image Blob 120 to the Cellular Provider 106. The Cellular Provider 106 may relay the Image Blob 120 to the KGLS Software Application 102. The Image Blob 120 may be acquired in real-time or alternatively acquired at an earlier time and stored. The Satellite Imaging Provider 108 may be configured to accept the Address Location Request 118 and in real-time and determine the coordinates and locate the Customer Address Location.

In an alternative embodiment, the Satellite Imaging Provider 108 may have previously imaged an area around the Customer Address Location and may post process the coordinates and locate the Customer Address Location from the stored Image Blob 120. Additionally, upon submission of the Customer Address by the Customer 116, an Address Location Request 118 may be communicated to a Property Records Database 148. The Property Records Database may contain Property Records for at least periphery data for the Customer Address Location and may be accessed near real-time. The periphery data may be used to calculate a square footage amount for the Customer Address Location. The Image Blob 120 and the Property Records may be communicated to the Image AI of the KGLS Software Application 102. Continuing with reference to FIG. 1A, the Imaging Satellite Provider 108 may image a Cell 1 of N 122, where N may be any number greater than 1, and generate raw images of the Address Location 112a . . . 112n contained within the Cell 1 of N 122. A cell may be any size or shape, it may be densely populated with Address Locations (residences/properties to be serviced) located close to each other or remote with Address Locations located far apart from each other. The Cell may a town, a collection of abutting towns, a county, a collection of abutting counties, or any other reasonable size, shape, or location.

According to an example embodiment, the Image Blob 120 is processed by the Image AI and may determine a set of Image Parameters (not shown). The Image Parameters may be communicated to an Estimation AI of the KGLS Software Application 102. The Estimation AI may access at least the CELL Database 104, a Weather Database 152, a Consumer Spending Database 154, GPS Tracking Database 150, or a combination thereof, and retrieve a set of Estimation Parameters (not shown). The Estimation AI may determine, based on the Image Parameters and the Estimation Parameters, details regarding the type of services to be provided, an optimized cost to perform the services and an optimized price quotation.

The details regarding the type of services to be provided may be communicated to a Scheduling Component (not shown) of the KGLS Software Application 102. The Scheduling Component may determine an optimized Lawn Service Provider and an optimized Date and Time of service. The Price Quotation and the optimized Date and Time of service may be provided to the Customer 116 through the User Interface of the KGLS Software Application 102. In an alternative embodiment, the KGLS Software Application 102 may communicate a request for a plurality of Address Locations located within the Cell (N), where N is equal to 1 to any number greater than 1.

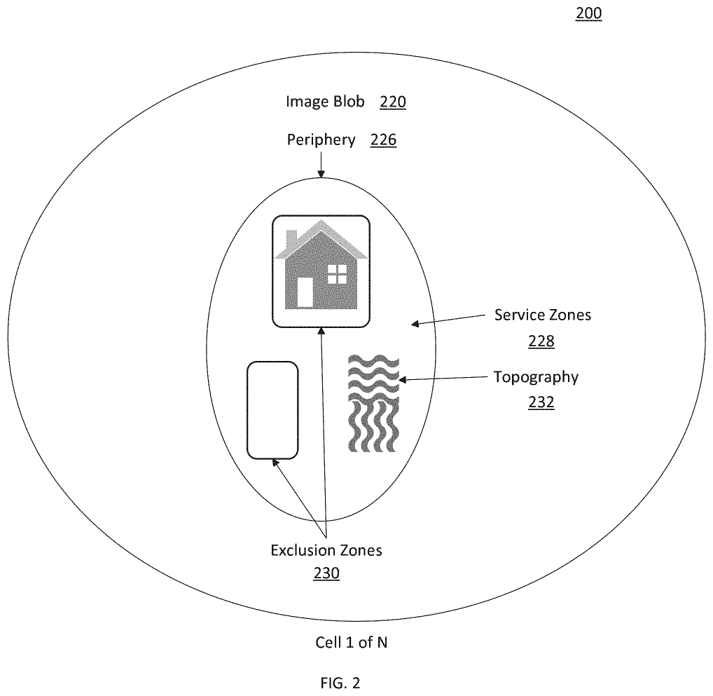

The Imaging Satellite Provider 108 may provide the KGLS Software Application 102 with N number of Image Blobs related to an individual Cell (N), such as the cell 1 of N 122. The Image AI and the Estimation AI may be run on the N number of Image Blobs and a Price Quotation may be directly marketed to the Customers within Cell (N). The Price Quotation may include a Community Discount if the potential Customers can create a community that may be serviced during a single service visit. In one example embodiment, an Image Blob of an Address Location contained within a Cell 1 of N 122, is depicted in FIG. 2, disclosed further below. FIG. 1B is a flow diagram 180 of an example embodiment of a computer-implemented method for automating lawn service price estimation and scheduling. The computer-implemented method begins (182) and determines at least one physical feature of a topography (184). The topography is associated with a received physical address of a residence (property). The received address identifies a physical location associated with the topography. The computer-implemented method estimates parameters to perform a lawn service at the residence based on the at least one physical feature determined (186). The estimating employs machine learning. The computer-implemented method computes a cost estimate for the lawn service at the residence, automatically, based on the parameters estimated (188). The computer-implemented method computes a price estimate based on at least the cost estimate for lawn services at the residence (190) and outputs the price estimate computed to an electronic device (192). The method thereafter ends (194) in the example embodiment.

The machine learning may employ position and time tracking information obtained from at least one global positioning system (GPS) coupled to lawn service equipment employed for performing the lawn service. The estimating may include employing at least one neural network for performing the machine learning. Determining the at least one physical feature may be based on satellite imagery of the topography.

The at least one physical feature may include service zones, complexity of the topography, exclusion zone, or a combination thereof, of the topography. The complexity may be based on at least one gradient of the topography.

The computing may be based on at least one constraint for performing the lawn service. The at least one constraint may include a maximum number of persons for performing the lawn service, a maximum amount of time for performing the lawn service, at least one type of equipment for performing the lawn service, or a combination thereof.

The computing may be based on a wealth profile of a community within which the residence resides. The computing may be based on an expected gross margin. The computing may be based on an expected amount of gasoline to be consumed by equipment for performing the lawn service. The computing may be based on a target profit amount for performing the lawn service.

The computer-implemented method may further comprise determining a schedule for at least one person employed for performing the lawn service, the schedule determined based on the estimating and the physical location. The lawn service may comprise mowing, trimming, blowing, collecting, or a combination thereof, of grass of the topography. It should be understood, however, that the lawn service is not limited thereto. Such a schedule may be determined by the KGLS Software Application 102 of FIG. 1A, disclosed in further detail below,

FIG. 2 is a schematic view of an example embodiment of an image blob 220 of the automated lawn service price estimation and scheduling system of FIG. 1A. The Image Blob 220 may have at least a periphery (border) 226, service zones 228, exclusion zones 230, and a topography 232. The Image Blob 220 may be analyzed by the Image AI and details regarding the periphery 226, service zones 228, exclusion zones 230, and the topography 232, may be determined. The Image AI may also analyze data received from the Property Records Database disclosed above with regard to FIG. 1A.

Continuing with reference to FIGS. 1 and 2, the Image AI may use both the Image Blob 220 and the Property Records to determine details regarding the periphery 226. In alternate embodiments, the Image AI may only use the Image Blob 220 or only the Property Records to determine details regarding the periphery 226. The periphery 226 may detail the total square footage of the topography 232 within the periphery (boarder) 226 of the Address Location 112a . . . 112n. The Image AI may also determine exclusion zones 230 where lawn services may not be required. These exclusion zones 230 may include at least a driveway, a structure such as a house, barn or shed, a water source such as a pond, stream or swimming pool and trees or landscaped areas, or combination thereof, for non-limiting example.

The square footage of the exclusion zones 230 may be subtracted from the total square footage of the topography 232 leaving the square footage of the service zones 228. The types of service may be determined by further analysis of the service zones 228 by the Image AI. The types of service may include at least lawn mowing, trimming (weed whacking), pruning bushes, grass (leaf) blowing and collection, or combination thereof, for non-limiting example. The Image AI may also determine a complexity parameter based on the topography 232 of the Address Location 112a . . . 112n.

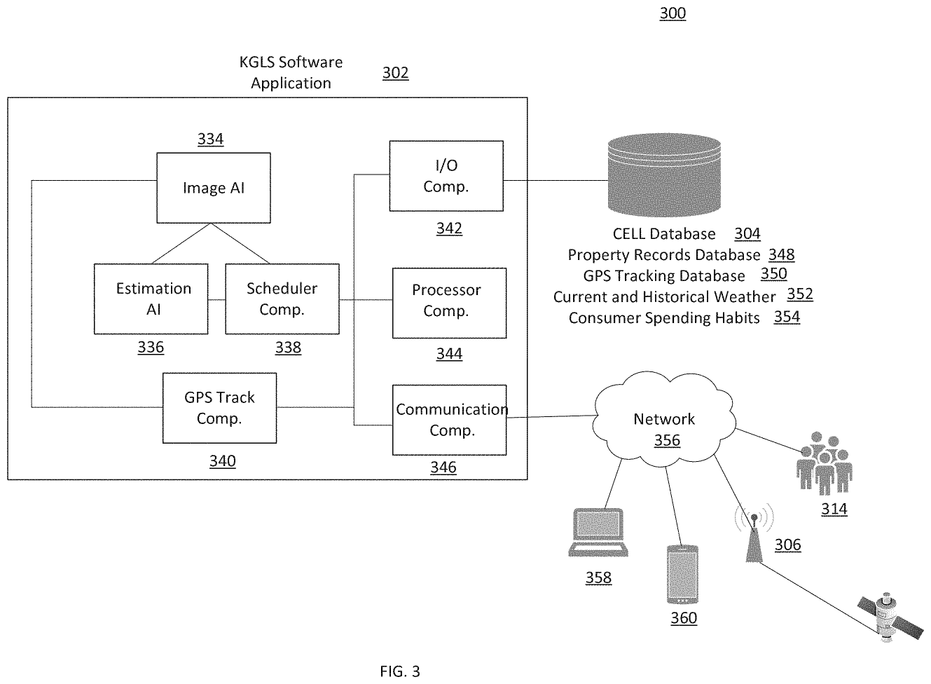

The topography 232 of the Address Location may include at least flat areas, convex areas (hills) and concave areas (valleys), or combination thereof, for non-limiting example. Lawn services may be more difficult to perform in the convex and concave areas. Lawn Service Providers 114 may provide lawn services by using motorize (driven) or non-motorize (push) type mowing equipment. Service Zones of the Service Zones 228 requiring non-motorized mowing equipment may be less efficient and cost more to provide the lawn service per square footage. Alternatively, Service Zones of the Service Zones 228 requiring motorized mowing equipment may be more efficient and cost less to provide the lawn service per square footage. An example embodiment of the KGLS Software Application 102 of FIG. 1A and Peripheral I/O and Communication Devices, is depicted in FIG. 3, disclosed below.

FIG. 3 is a schematic view of an example embodiment of the KGLS Software Application 102 and Peripheral I/O and Communication Devices of the automated lawn service price estimation and scheduling system 100 of FIG. 1A. With reference to the example embodiment of FIG. 3, the KGLS Software Application 302 may include at least an Image AI 334, an Estimation AI 336, a Scheduler Component 338, a GPS Tracking Component 340, Input/Output Component 342, a Processor 344 and a Communication Component 346.

The Peripheral I/O includes at least the CELL Database 304, Property Records Database 348, GPS Tracking Database 350, Current and Historical Weather Database 352 and Consumer Spending Habits Database 354. The Communication Devices include at least a Network 356, a Customer (User) computer 358 and/or smart phone 360, Cellular Providers 306, Image Satellite Providers 308, and Lawn Service Providers 314. A general description of the KGLS Software Application 302 and Peripheral I/O and Communication Devices has been provided above and a more detailed functional description of individual components is disclosed below.

The GPS Tracking Component 340 may receive tracking data regarding the mowing equipment from the GPS Tracking Database 350. In an alternative embodiment, the GPS Tracking Component 340 may receive tracking data directly from the mowing equipment (not shown). The mowing equipment may be equipped with a GPS tracking computer (not shown) configured to track GPS Tracking Parameters for each lawn service provided. The GPS Tracking Parameters may include at least the distance traveled by the mowing equipment, the time and date the mowing equipment was in use, the amount of time the mowing equipment was in use and the amount of gas consumed by the mowing equipment for non-limiting example. The GPS Tracking Parameters may be communicated to the Image AI 334 for deep learning AI based decision making.

Continuing with reference to FIGS. 1-3, the Image AI 334 may determine the Image Parameters based on the analysis of the Image Blob (120, 220) and a given Property Record(s) of the Property Records Database 348. The GPS Tracking Parameters may include actual data regarding the square footage of the service zones 228 and may be used by the Image AI 334 to deep learn and improve the analysis for the Image Parameters, or more specifically, at least the periphery 226 and the service zones 230.

In an alternative embodiment, the GPS Tracking Component 340 may track the time and dates the mowing equipment was in use and verify that the mowing equipment was being used for scheduled lawn services. The GPS Tracking Parameters may be communicated to the Estimation AI 336 for deep learning AI based decision making. The Estimation AI 336 may determine, based on the Image Parameters and the Estimation Parameters, details regarding the type of services to be provide, an optimized cost to perform the services and an optimized price quotation. The GPS Tracking Parameters may include actual data regarding at least the amount of time the mowing equipment was in use and the amount of gas consumed by the mowing equipment and may be used by the Estimate AI 336 to deep learn and improve the analysis for at least the type of services to be provide, the optimized cost to perform the services and the optimized price quotation.

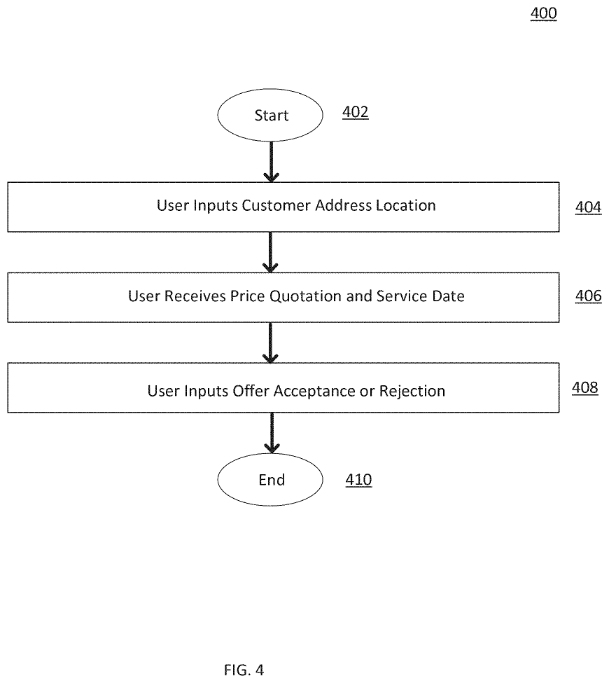

The Processor Component 344 may be configured to process computer readable medium with program codes, the I/O Component 342 may be configured to connect and communicate with peripheral device over any reasonable standard protocol and the Communication Component 346 may be configured to communicate with network devices over any reasonable wired or wireless communications protocol. An example embodiment of the KGLS Software Application 302 User Interface method is disclosed below with regard to FIG. 4.

FIG. 4 is a flow diagram 400 of an example embodiment of a User Interface method for the KGLS Software Application 102 and 302 disclosed above with regard to FIG. 1A and FIG. 3, respectively. With reference to FIG. 4, the user interface method begins (402) and includes at least the following actions:
The Customer inputs the Customer Address Location (404)
The Customer receives from the user interface a price quotation and service date (406)
The Customer accepts or rejects the price quotation and service date (408)
   The method thereafter ends (410) in the example embodiment.

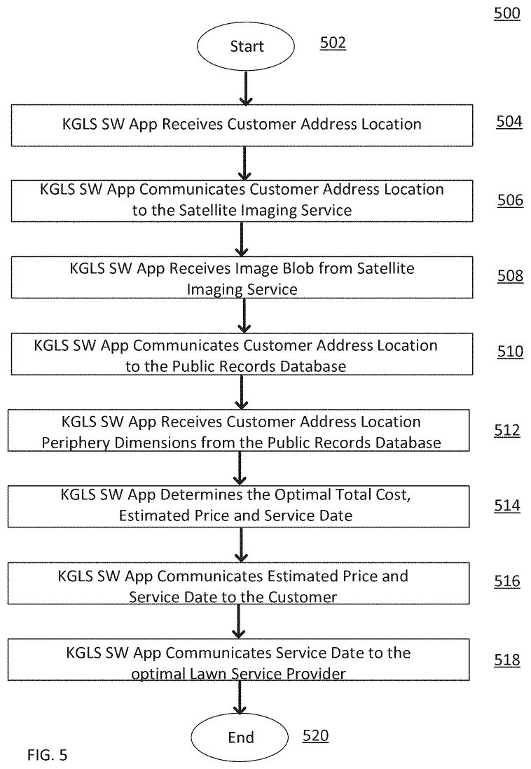

FIG. 5 is a flow diagram 500 of an example embodiment of a method of the Software Application of FIG. 3. In one example embodiment, the KGLS Software Application method is depicted in FIG. 5. In the example embodiment of FIG. 5, the method begins (502) and the KGLS Software Application method includes performing at least the following actions:
The KGLS Software Application receives a Customer Address Location (504)
The KGLS Software Application communicates the Customer Address Location to the Satellite Imaging Service (506)
The KGLS Software Application receives an Image Blob from the Satellite Imaging Service (508)
The KGLS Software Application communicates the Customer Address Location to the Public Records Database (510)
The KGLS Software Application receives Customer Address Location Periphery data from the Public Records Database (512)
The KGLS Software Application determines the optimal total cost, estimated price and service date (514)
The KGLS Software Application communicates the estimated price and service date to the Customer (516)
The KGLS Software Application communicates service date to the optimal lawn service provider (518)
   The method thereafter ends (520) in the example embodiment.

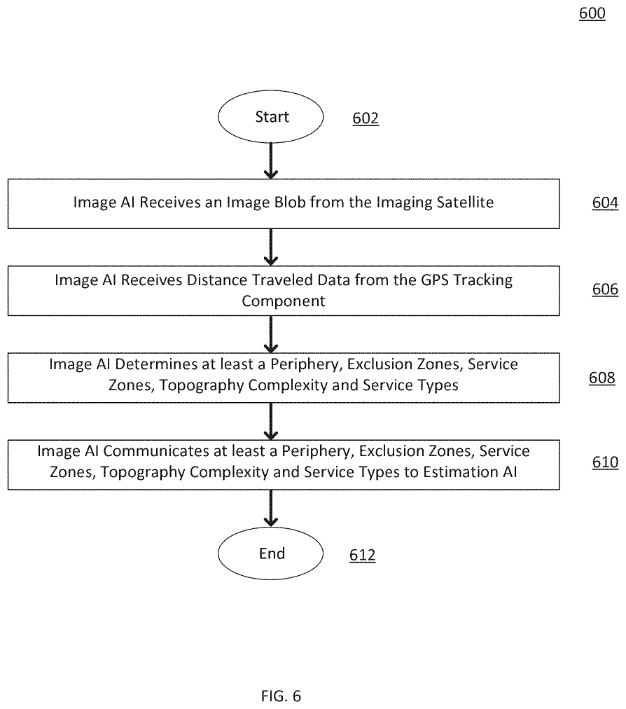

FIG. 6 is a flow diagram 600 of an example embodiment of an Image AI method for the Software Application of FIG. 3, disclosed above. The Image AI method begins (602) and includes performing at least the following actions:
The Image AI receives an Image Blob from the imaging satellite (604)
The Image AI receives distance traveled data from the GPS tracking component (606)
The Image AI determines at least a periphery, exclusion zone, service zone, topography complexity and service types (608)
The Image AI communicates data regarding at least a periphery, exclusion zone, service zone, topography complexity and service types to the Estimation AI (610)
   The method thereafter ends (612) in the example embodiment.

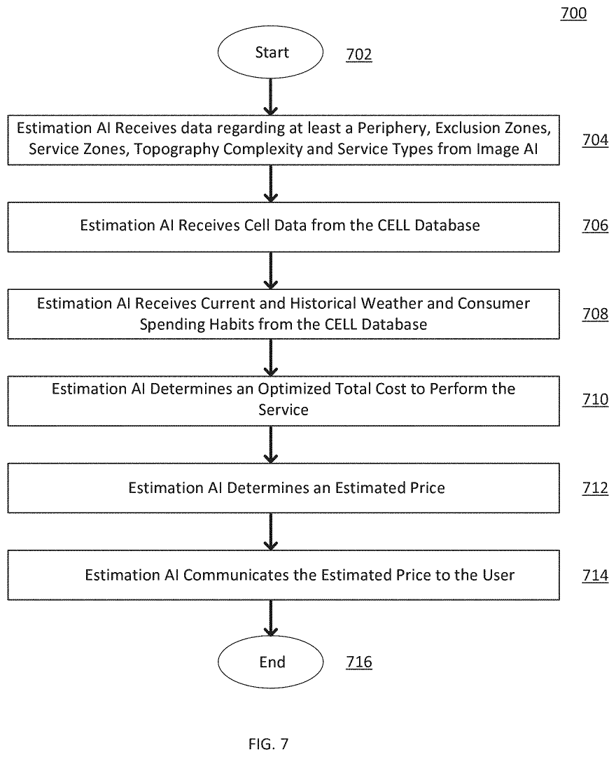

FIG. 7 is a flow diagram 700 of an example embodiment of an Estimation AI method for the Software Application of FIG. 3, disclosed above. The Estimation AI method begins (702) includes performing at least the following actions:
The Estimation AI receives data regarding at least a periphery, exclusion zone, service zone, topography complexity and service types from the Image AI (704)
The Estimation AI receives Cell Data from the CELL Database (706)
The Estimation AI receives current and historical weather data and consumer spending habits from the CELL Database (708)
The Estimation AI determines an optimized total cost to perform the service (710)
The Estimation AI determines an estimate price (712)
The Estimation AI communicates the estimated price to the Customer (714)
   The method thereafter ends (716) in the example embodiment.

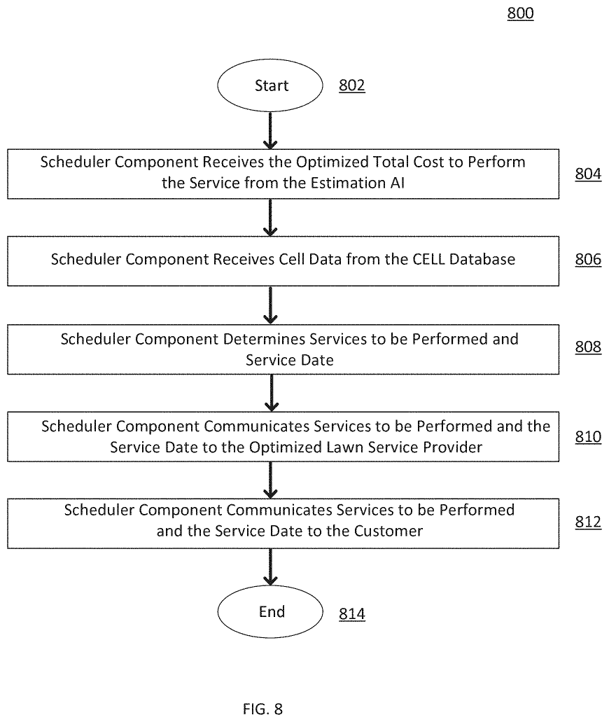

FIG. 8 is a flow diagram 800 of an example embodiment of a Scheduler Component method for the Software Application of FIG. 3, disclosed above. The Scheduler Component method begins (802) and includes performing at least the following actions:
The Scheduler Component receives the optimized total cost to perform the service from the Estimation AI (804)
The Scheduler Component receives cell data from the CELL Database (806)
The Scheduler Component determines services to be performed and a service date (808)
The Scheduler Component communicates the services to be performed and the service date to the optimized lawn service provider (810)
The Scheduler Component communicates services to be performed and service date to the Customer (812)
   The method thereafter ends (814) in the example embodiment.

### Example Embodiments of Use Cases

According to an example embodiment a customer inputs an address location into the KGLS service; the Customer is provided with a price and a service date; the Customer may accept or reject the offer for lawn services. The KGLS software application takes in the Customer address location; the Customer address location is provided to google earth (or any other satellite imaging service); the satellite imaging service determines the coordinates and locates the Customer address location; the satellite imaging service images (stored images) the Customer address location and provides parameters to the KGLS software application; the parameters include an image blob having at least a periphery and shaded areas within the periphery; the shaded areas may include exclusion zones or service zones having changes in topography; exclusion zones may include a building (house, barn, shed), driveway, wooded area, body of water (pool, pond, river, swap) or any other obstruction; service zones having changes in topography may include substantially flat areas, convex areas (hills) or concave areas (valleys) within the periphery; the KGLS software analyzes the parameters and determines which areas may require lawn care services (at least mowing, trimming and blowing); KGLS software application also accesses a CELL Database; the CELL Database maintains information related to individual cells within the Automated Lawn Service Estimation system; a cell may cover a defined geographic area (several towns) having a plurality of Customers and KGLS Lawn Service Providers; the CELL Database information may include a list of KGLS Lawn Service Providers, a list of active Customers, Economic Information related to CELL Wealth, Employee Hourly Rates, Variable Service Costs (gas and other consumables), Distance between KGLS Lawn Service Providers location and the Customer address location, Weather History and Soil Makeup; KGLS software determines, based on the parameters and the CELL Database information, the most efficient estimated cost and pricing model for the lawn services; the cost components may comprise at least TotalServiceZoneArea, NumberOfLawnServiceProfs, HourlyRates, TravelDistance, PriceOfGas, WeightedComplexity, ServiceType (mow, trim, blow); after determining the most efficient cost model (MEC) the KGLS software determines the optimized pricing model for each individual Customer; the price components comprise at least the MEC, CellWealth, and an OptimizedProfit; the OptimizedProfit is a function of CellWealth wherein the CellWealth is determined by deep machine learning AI focused on the spending characteristics of the Customers in each individual Cell; after determining the OptimizedProfit the KGLS determines the optimized price for each individual Customer.

In one embodiment, a problem solved by the KGLS Automated Lawn Service Estimation and Scheduling system is to provide an optimized price to the Customer without the Lawn Service Provider having to visit the individual Customer Address Location within each individual Cell. The example embodiments of the KGLS Automated Lawn Service Estimation and Scheduling system are non-limiting and not limited to lawn services. Alternative embodiments of the KGLS Automated Lawn Service Estimation and Scheduling system may include any service that requires remote estimation and instantaneous price quotation. These services may include at least re-roofing, house cleaning, landscaping, tree removal, excavating and any other service that requires the service provider to visit the individual Customer Address Location within each individual Cell to provide price estimations. Kelly Green Lawn Services (KGLS) was founded by two students, one a sophomore in high school and the other a first-year college student. In one embodiment, the KGLS Automated Lawn Service Estimation and Scheduling system may be used to expand KGLS from a single Cell to N Cells located throughout the United States. KGLS may offer to provide lawn service equipment to young, high school or college aged, Lawn Service Providers in order to create a Cell (N). The lawn service equipment may be leased to own by the Lawn Service Providers. In alternative embodiments, the lawn service equipment may be owned by KGLS or by the Lawn Service Providers. Customers may interact with the KGLS Automated Lawn Service Estimation and Scheduling system as described providing price quotations to Customers and scheduling Lawn Service Providers through the United States.

While example embodiments have been particularly shown and described, it will be understood by those skilled in the art that various changes in form and details may be made therein without departing from the scope of the embodiments encompassed by the appended claims.

What is claimed is:

1. A computer-implemented method for automating lawn service price estimation and scheduling, the computer-implemented method comprising:
determining at least one physical feature of a topography, the topography associated with a received physical address of a residence, the received address identifying a physical location associated with the topography;
estimating parameters to perform a lawn service at the residence based on the at least one physical feature determined, the estimating employing machine learning;
computing a cost estimate for the lawn service at the residence, automatically, based on the parameters estimated;
computing a price estimate based on at least the cost estimate for lawn services at the residence; and
outputting the price estimate computed to an electronic device.

2. The computer-implemented method of claim 1, further comprising wherein the machine learning employs position and time tracking information obtained from at least one global positioning system (GPS) coupled to lawn service equipment employed for performing the lawn service.

3. The computer-implemented method of claim 2, wherein the estimating includes employing at least one neural network for performing the machine learning.

4. The computer-implemented method of claim 1, wherein determining the at least one physical feature is based on satellite imagery of the topography.

5. The computer-implemented method of claim 1, wherein the at least one physical feature includes service zones, complexity of the topography, exclusion zone, or a combination thereof, of the topography.

6. The computer-implemented method of claim 1, wherein the complexity is based on at least one gradient of the topography.

7. The computer-implemented method of claim 1, wherein the computing is based on at least one constraint for performing the lawn service.

8. The computer-implemented method of claim 1, wherein the at least one constraint includes a maximum number of persons for performing the lawn service, a maximum amount of time for performing the lawn service, at least one type of equipment for performing the lawn service, or a combination thereof.

9. The computer-implemented method of claim 1, wherein the computing is based on a wealth profile of a community within which the residence resides.

10. The computer-implemented method of claim 1, wherein the computing is based on an expected gross margin.

11. The computer-implemented method of claim 1, wherein the computing is based on an expected amount of gasoline to be consumed by equipment for performing the lawn service.

12. The computer-implemented method of claim 1, wherein the computing is based on a target profit amount for performing the lawn service.

13. The computer-implemented method of claim 1, further comprising determining a schedule for at least one person employed for performing the lawn service, the schedule determined based on the estimating and the physical location.

14. The computer-implemented method of claim 1, wherein the lawn service comprises mowing, trimming, blowing, collecting, or a combination thereof, of grass of the topography.

15. An apparatus for automating lawn service price estimation and scheduling, the apparatus comprising:
at least one memory having encoded thereon a sequence of instructions; and
at least one processor coupled to the at least one memory, the at least one processor configured to load and execute the sequence of instructions causing the at least one processor to:
determine at least one physical feature of a topography, the topography associated with a received physical address of a residence, the received address identifying a physical location associated with the topography;
estimate parameters to perform a lawn service at the residence based on the at least one physical feature determined, the estimating employing machine learning;
compute a cost estimate for the lawn service at the residence, automatically, based on the parameters estimated;
compute a price estimate based on at least the cost estimate for lawn services at the residence; and
output the price estimate computed to an electronic device.

16. A non-transitory computer-readable medium for automating lawn service price estimation and scheduling, the non-transitory computer-readable medium having encoded thereon a sequence of instructions which, when loaded and executed by a processor, causes the processor to:
determine at least one physical feature of a topography, the topography associated with a received physical address of a residence, the received address identifying a physical location associated with the topography;
estimate parameters to perform a lawn service at the residence based on the at least one physical feature determined, the estimating employing machine learning;
compute a cost estimate for the lawn service at the residence, automatically, based on the parameters estimated;
compute a price estimate based on at least the cost estimate for lawn services at the residence; and
output the price estimate computed to an electronic device.
